(19) United States
(12) Patent Application Publication
(10) Pub. No.: US 2007/0121005 A1
(43) Pub. Date: May 31, 2007

(54) Adaptation of close-captioned text based on surrounding video content

(75) Inventors: Srinivas Gutta, Eindhoven (NL); Petrus Meuleman, Eindhoven (NL); Wilhelmus Franciscus Johannes Verhaegh, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/578,718

(22) PCT Filed: Nov. 8, 2004
(86) PCT No.: PCT/IB04/52340

§ 371 Date: May 10, 2006

Related U.S. Application Data
(60) Provisional application No. 60/518,924, filed on Nov. 10, 2003.

(51) Int. Cl. H04N 7/08; H04N 11/00; H04N 7/16

(52) U.S. Cl. 348/468; 725/137

(57) ABSTRACT

A method for displaying close-captioned text (116) associated with video is provided. The method including: determining a position on a portion of the video for display of the close-captioned text; detecting one or more attributes of the video surrounding the position; and adjusting one or more attributes of the close-captioned text based on the detected one or more attributes of the video. The method can further include displaying the close-captioned text in the portion of the video with the adjusted one or more attributes. The one or more attributes of the video surrounding the position can be selected from a list consisting of a brightness, a contrast, a color, and a content. The one or more attributes of the close-captioned text can be selected from a group consisting of a brightness, a contrast, a color, and a degree of transparency.

The present invention relates generally to displaying video content containing close-captioned text (alternatively referred to as “close-captioning”), and more particularly, to apparatus and methods for adaptation of close-captioned text based on surrounding video content.

Close-captioned text is used on televisions and other monitors to display text corresponding to the audio portion of video content being displayed. The attributes (e.g., color, brightness, contrast, etc.) of the close-captioned text are fixed irrespective of the attributes of the video content surrounding the closed-captioned text. This is particularly a problem where the video content surrounding the close-captioned text is the same color as the close-captioned text. In other situations, a weaker contrast of the closed-captioned text may be preferable. For instance, very bright white text in a dark scene may be distracting or disturbing to a viewer. Other attributes of the video content surrounding the closed captioned text, such as contrast, brightness, and the presence of foreground objects at the location of the close-captioned text pose additional problems.

Therefore it is an object of the present invention to provide methods and devices that overcome these and other disadvantages associated with the prior art.

Accordingly, a method for displaying close-captioned text associated with video is provided. The method comprising: determining a position on a portion of the video for display of the close-captioned text; detecting one or more attributes of the video surrounding the position; and adjusting one or more attributes of the close-captioned text based on the detected one or more attributes of the video.

The method can further comprise displaying the close-captioned text in the portion of the video with the adjusted one or more attributes.

The one or more attributes of the video surrounding the position can be selected from a list consisting of a brightness, a contrast, a color, and a content.

The one or more attributes of the close-captioned text can be selected from a group consisting of a brightness, a contrast, a color, and a degree of transparency.

The detecting can comprise: scanning a predetermined number of pixels in the video surrounding the position; and ascertaining an attribute of the pixels with a look-up table; and equating the ascertained attribute of the pixels with the one or more attributes of the video surrounding the position. The one or more attributes of the video surrounding the position can be a color and the look-up table can be a color look-up table.

The one or more attributes of the video surrounding the position can be a color and the adjusting can comprise choosing a different color of the close-captioned text.

The one or more attributes of the video surrounding the position can be at least one of brightness and contrast and the adjusting can comprise adjusting at least one of the brightness and contrast by a predetermined factor. The predetermined factor can be changeable by a user. The predetermined factor can be 50%.

The one or more attributes of the video surrounding the position can be a content of the video surrounding the position and the adjusting can comprise modifying a transparency of the close-captioned text by a predetermined factor.

Also provided is a device for displaying close-captioned text associated with video. The device comprising a processor for determining a position on a portion of the video for display of the close-captioned text, detecting one or more attributes of the video surrounding the position, and adjusting one or more attributes of the close-captioned text based on the detected one or more attributes of the video.

The device can further comprise a display for displaying the video, wherein the processor further displays the close-captioned text in the portion of the video with the adjusted one or more attributes.

The one or more attributes of the video surrounding the position can be selected from a list consisting of a brightness, a contrast, a color, and a content.

The one or more attributes of the close-captioned text can be selected from a group consisting of a brightness, a contrast, a color, and a degree of transparency.

The device can be selected from a list consisting of a television, a monitor, a set-top box, a VCR, and a DVD player.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

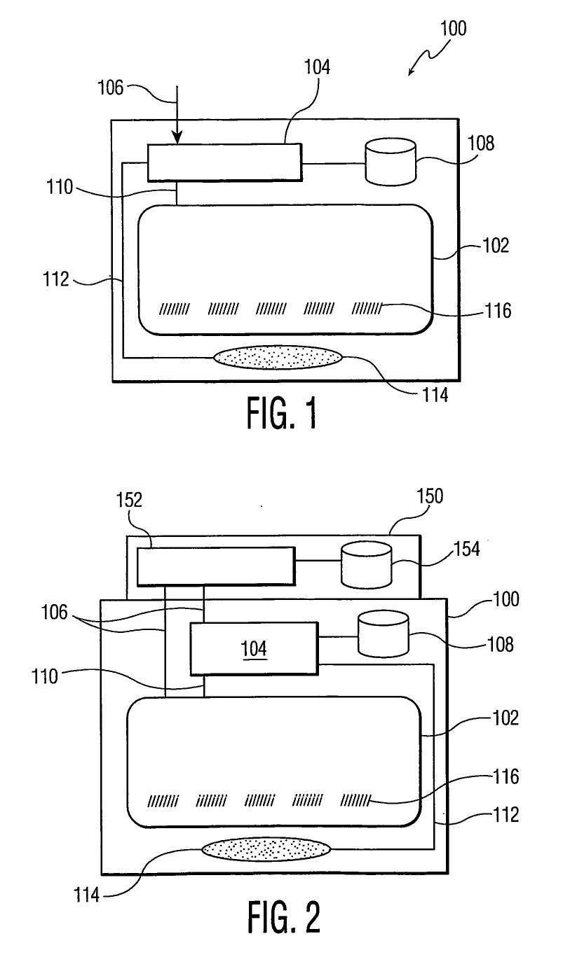

FIG. 1 illustrates a schematic of a first device for carrying out the methods of the present invention.

FIG. 2 illustrates a schematic of a second device for carrying out the methods of the present invention.

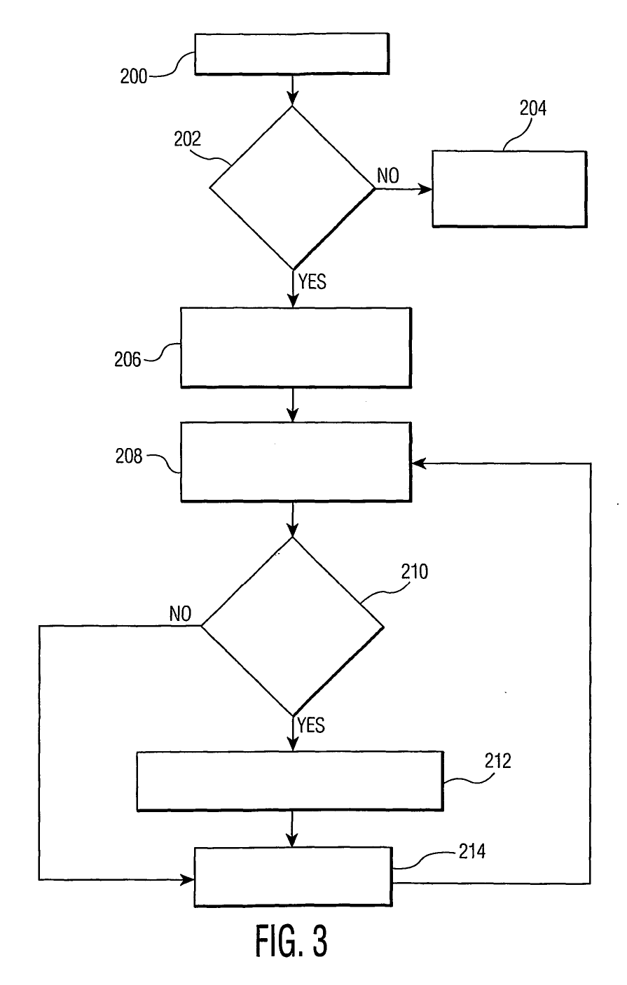

FIG. 3 illustrates a flow chart of a preferred method according to the present invention.

Although this invention is applicable to numerous and various types of display devices, it has been found particularly useful in the environment of televisions. Therefore, without limiting the applicability of the invention to televisions, the invention will be described in such environment. Those skilled in the art will appreciate that other types of display devices which display video and close-captioned text can be utilized in the methods and with the devices of the present invention, such as a computer monitor, a cellular telephone display, and a personal digital assistant display.

Referring now to FIG. 1, there is illustrated a first device for displaying close-captioned text associated with video, the first device being configured as a television 100. The television has a display screen 102 such as a CRT, and LCD, or a projection screen. The television 100 further has a processor 104 that receives a video content (hereinafter referred to simply as “video”) input signal 106. The video input signal 106 can be from any source known in the art, such as cable, broadcast television, satellite, or an external source such as a tuner, VCR, DVD, or set-top box. The processor 104 is further operatively connected to a storage device 108 for storing data, settings, and/or program instructions for carrying out the conventional functions of the television 100 as well as the methods of the present invention. Although shown as a single storage device 108, the same may be implemented in several separate storage devices that may be any of many different types of storage devices known in the art.

The processor 104 receives the video input signal 106, processes the same, as necessary, as is known in the art and outputs a signal 110 to the display screen in a format compatible with the display screen 102. The display screen 102 displays a video portion of the video input signal 106. An audio portion 112 of the video input signal 106 is reproduced on one or more speakers 114 also operatively connected to the processor 104. The one or more speakers 114 may be integral with the television 100, as shown in FIG. 1 or separable therefrom. The video input signal 106 includes a close-captioned text portion for reproducing close-captioned text 116 on a portion of the display screen 102. As is known in the art, a user can program the television 100 through a user interface to display the close-captioned text 116. The user may also program the language and position of the close-captioned text 116 on the display screen 102 with the user interface. Absent such programming, the close-captioned text 116 generally defaults to a certain language and position, such as English and across a bottom of the display screen 102. The use of close-captioned text 116 is very useful for people who are hearing impaired and in situations where audio is inappropriate, such as locations where the television is not the main focus and is viewed in the background, such as in a bar or a sports club.

Referring now to FIG. 2, there is shown a second device for displaying close-captioned text 116 associated with video, the second device being configured as an external source, such as a set-top box, tuner, computer, DVD, or VCR. The external source is generally referred to herein by reference numeral 150 and refers generally to any device that supplies a video input signal to a display device, such as the television 100. In the configuration of FIG. 2, the television 100 may be as configured in FIG. 1 or it may simply be a monitor under the control of a processor 152 contained in the external source 150. Thus, as shown in FIG. 2, the input video signal 106 from the processor 152 of the external source 150 may be directly input to the display screen 102 or to the display screen via the television processor 104. The processor 152 is operatively connected to a storage device 154 which may be implemented as one or more separable storage devices. The storage device 154 includes data and settings as well as program instructions for the normal operation of the external source and/or television 100 as well as for carrying out the methods of the present invention.

As will be discussed below, depending upon the configuration of the device, the processor 104, 152 determines a position on a portion of the video for display of the close-captioned text 116, detects one or more attributes of the video surrounding the position, and adjusts one or more attributes of the close-captioned text 116 based on the detected one or more attributes of the video. As discussed above, the position of the close-captioned text 116 may be assigned by a default or set by the user, in either way, its location can be determined by accessing a location in the storage device 108, 154 where such settings are stored. Furthermore, the detection of attributes of video is well known in the art, such as determining a color, brightness, contrast, and content of the video by analyzing the pixels that make up the video at the desired position. Lastly, the adjustment of one or more attributes of the close-captioned text, such as color, brightness, contrast, and degree of transparency is also well known in the art, such as assigning the pixels which make up the close-captioned text 116 appropriate values, which can be taken from appropriate lookup tables, also stored in the storage device 108, 154. After the adjustment to the one or more attributes of the close-captioned text 116 is made, the processor 104, 152 further displays the close-captioned text 116 in the portion of the video with the adjusted one or more attributes.

Referring now also to FIG. 3, a method for displaying close-captioned text associated with video will be described. At step 200 a video input signal is received. As discussed above, the video input signal includes close-captioned text corresponding to an audio portion of the video. The video signal can be received by any means known in the art, such as from cable, television broadcast, satellite, tuner, DVD, or VCR. At step 202, it is determined whether close-captioning is required either by the user or as a default of the device. If close-captioning is not required, the method proceeds to step 204 where the video is displayed on the display screen 102 without closed-captioned text. If it is determined that close-captioning is required, the method proceeds to step 206 where the location of the close-captioned text 116 is determined. Generally, the location of the closed-captioned text 116 is predefined and stored in memory, such as in the storage device 108, 154. At step 208, one or more attributes of the video surrounding the position of the closed-captioned text 116 is detected. As discussed above, such attributes can be the color, brightness, contrast, and content of the video. The content of the video refers to the detection of objects in the video surrounding the position of the close-captioned text 116. For example, it may be detected that a person's head is displayed in the position surrounding the close-captioned text 116 and that the person's head is the most prominent head detected in the video. The detection of the one or more attributes of the video surrounding the close-captioned text 116 can be continuous or sampled at predetermined intervals or frames.

At step 210 it is determined whether one or more of the attributes of the close-captioned text 116 needs to be adjusted based on the detected attributes of the video surrounding the close-captioned text. If it is determined that the one or more attributes of the close-captioned text 116 does not need adjustment, the method proceeds to step 214 where the video and (unadjusted) close-captioned text are displayed. After step 214, the method loops back to step 208 where the video surrounding the close-captioned text 116 is continually detected and monitored. As discussed above, this determination can be made continuously or at certain predetermined intervals or frames. The determination at step 208 can also be made only when the close-captioned text 116 is about to be replaced with new text. Furthermore, the determination at step 208 can include an analysis of whether a motion vector from one frame of the video to another frame is above a set threshold, thus, signaling an end of one video clip or portion and the start of another vide clip or portion. Techniques for detecting motion and for detecting the beginning and ending of video clips are well known in the art.

If it is determined that one or more of the attributes of the close-captioned text needs to be adjusted, the method proceeds to step 212, where one or more attributes of the close-captioned text 116 are adjusted based on the detected attributes of the video surrounding the close-captioned text 116. The attributes of the close-captioned text are generally known to the device, such as being stored in a settings portion of the storage device 108, 154. As discussed above, the attributes of the close-captioned text 116, are generally set by the device but may be changed by the user through a user interface.

The determination at step 210 generally involves a comparison of the attributes of the close-captioned text 116 with the attributes of the video surrounding the close-captioned text 116. Any number of ways known in the art can be utilized for determining whether an adjustment in the close-captioned text 116 is necessary. For example, if one or more of the attributes of the close-captioned text 116 differs from a corresponding attribute of the video surrounding the close-captioned text by a value less than a predetermined threshold. For example, if the color of the close-captioned text has a color value very similar to a color value of at least a portion of the color value of the video surrounding the close-captioned text 116, the method can determine that an adjustment in the color of the closed-captioned text 116 is necessary. Similar determinations can be made with regard to other attributes such as contrast and brightness. Where the attribute of the video surrounding the closed-captioned text is the content of the video, the closed-captioned text can be adjusted at step 212 to change its degree of transparency to allow the user to view objects through the close-captioned text 116. In the example described above, the viewer can view the prominent person in the video through the transparent closed-captioned text 116.

The determination at step 210 can be done considering the close-captioned text and surrounding video on the whole or in portions thereof. For example, the determination can be made for each letter or word in the closed-captioned text 116 and the corresponding video surrounding each letter or word. Alternatively, the determination at step 210 can be done for the closed-captioned text as a whole, e.g., for all the closed captioned text that is to be displayed at any one moment. If the determination at step 210 is done for selected portions of the close-captioned text 116, any adjustments made to the attributes of the close captioned text 116 should be such that a smooth transition is made between adjustments in each of the portions. If the determination at step 210 is done on the close-captioned text 116 as a whole, any adjustment at step 212 made to the attributes of the close-captioned text should be done based on all of the video surrounding the closed-captioned text. For example, if the video surrounding the close-captioned text contains red, green, and blue pixels, the determination to adjust the color of the close-captioned text should not include changing the same to either of red, green, or blue. In such a circumstance, the close-captioned text 116 should be changed to a color different from all of red, green, and blue. Alternatively, the change in the color of the close-captioned text 116 can be a similar color that is modified by a predetermined factor. For example, if the color of the video surrounding the close-captioned text 116 and the color of the close-captioned text are both the same color or within a predetermined threshold of the same color (e.g., both are red or very similar reds), the color of the close-captioned text 116 can be changed to another red within a predetermined factor (e.g., a brick red instead of a cherry red). Similarly, where the one or more attributes of the video surrounding the close-captioned text 116 is brightness and/or contrast and it is determined at step 210 that the contrast and/or brightness of the closed-captioned text 116 needs to be adjusted, the brightness and/or contrast of the closed-captioned text can be adjusted by a predetermined factor, such as by 50%. For example, if the video surrounding the close-captioned text 116 is very dark and the close-captioned text 116 has a high brightness, the brightness of the close-captioned text 116 can be reduced by 50% or any other predetermined factor. The predetermined factor can be changeable by the user through a suitable user interface.

It is important to note that when changing any of the attributes of the close-captioned text 116, care should be taken such that the perceptive quality of the video is not lost. For example, if the color of the video surrounding the position of the close-captioned text 116 is white, if the color of the close-captioned text 116 is changed to a dark red, the user could be attracted to the close-captioned text and loose or detract from the overall view of the video. Thus, a milder color should be chosen for the close-captioned text 116 to prevent the user from losing or being distracted from the video.

After adjustments are made to one or more of the attributes of the close-captioned text 116 at step 212, the method proceeds to step 214 where the close-captioned text 116 having the adjusted attributes are displayed at the selected position on the video screen 102 along with the corresponding video. The method then loops back to step 208 for detection and monitoring of one or more of the attributes of the video surrounding the close-captioned text 116.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for displaying close-captioned text associated with video, the method comprising:
determining a position on a portion of the video for display of the close-captioned text (116);
detecting one or more attributes of the video surrounding the position; and
adjusting one or more attributes of the close-captioned text based on the detected one or more attributes of the video.

2. The method of claim 1, further comprising displaying the close-captioned text (116) in the portion of the video with the adjusted one or more attributes.

3. The method of claim 1, wherein the one or more attributes of the video surrounding the position is selected from a list consisting of a brightness, a contrast, a color, and a content.

4. The method of claim 1, wherein the one or more attributes of the close-captioned text (1160 is selected from a group consisting of a brightness, a contrast, a color, and a degree of transparency.

5. The method of claim 1, wherein the detecting comprises:
scanning a predetermined number of pixels in the video surrounding the position; and
ascertaining an attribute of the pixels with a look-up table; and
equating the ascertained attribute of the pixels with the one or more attributes of the video surrounding the position.

6. The method of claim 5, wherein the one or more attributes of the video surrounding the position is a color and the look-up table is a color look-up table.

7. The method of claim 1, wherein the one or more attributes of the video surrounding the position is a color and the adjusting comprises choosing a different color of the close-captioned text (116).

8. The method of claim 1, wherein the one or more attributes of the video surrounding the position is at least one of brightness and contrast and the adjusting comprises adjusting at least one of the brightness and contrast by a predetermined factor.

9. The method of claim 8, wherein the predetermined factor is changeable by a user.

10. The method of claim 8, wherein the predetermined factor is 50%.

11. The method of claim 1, wherein the one or more attributes of the video surrounding the position is a content of the video surrounding the position and the adjusting comprises modifying a transparency of the close-captioned text by a predetermined factor.

12. A device (100, 15) for displaying close-captioned text (116) associated with video, the device comprising a processor (104, 152) for determining a position on a portion of the video for display of the close-captioned text, detecting one or more attributes of the video surrounding the position, and adjusting one or more attributes of the close-captioned text based on the detected one or more attributes of the video.

13. The device of claim 12, further comprising a display (102) for displaying the video, wherein the processor (104, 152) further displays the close-captioned text (116) in the portion of the video with the adjusted one or more attributes.

14. The device of claim 12, wherein the one or more attributes of the video surrounding the position is selected from a list consisting of a brightness, a contrast, a color, and a content.

15. The device of claim 12, wherein the one or more attributes of the close-captioned text is selected from a group consisting of a brightness, a contrast, a color, and a degree of transparency.

16. The device of claim 12, wherein the device (100, 150) is selected from a list consisting of a television, a monitor, a set-top box, a VCR, and a DVD player.

17. A computer program product embodied in a computer-readable medium for displaying close-captioned text (116) associated with video, the computer program product comprising:
computer readable program code means for determining a position on a portion of the video for display of the close-captioned text;
computer readable program code means for detecting one or more attributes of the video surrounding the position; and
computer readable program code means for adjusting one or more attributes of the close-captioned text based on the detected one or more attributes of the video.

18. The computer program product of claim 17, further comprising computer readable program code means for displaying the close-captioned text (116) in the portion of the video with the adjusted one or more attributes.

19. The computer program product of claim 17, wherein the one or more attributes of the video surrounding the position is selected from a list consisting of a brightness, a contrast, a color, and a content.

20. The computer program product of claim 17, wherein the one or more attributes of the close-captioned text (116) is selected from a group consisting of a brightness, a contrast, a color, and a degree of transparency.

21. A program storage device readable by machine, tangibly embodying a program of instructions executable by the machine to perform method steps for displaying close-captioned text (116) associated with video, the method comprising:
determining a position on a portion of the video for display of the close-captioned text;
detecting one or more attributes of the video surrounding the position; and
adjusting one or more attributes of the close-captioned text based on the detected one or more attributes of the video.

22. The program storage device of claim 21, wherein the method further comprising displaying the close-captioned text (116) in the portion of the video with the adjusted one or more attributes.

23. The program storage device of claim 21, wherein the one or more attributes of the video surrounding the position is selected from a list consisting of a brightness, a contrast, a color, and a content.

24. The program storage device of claim 21, wherein the one or more attributes of the close-captioned text (116) is selected from a group consisting of a brightness, a contrast, a color, and a degree of transparency.
